(19) United States
(12) Patent Application Publication
(10) Pub. No.: US 2025/0050369 A1
(43) Pub. Date: Feb. 13, 2025

(54) FLEXIBLE STAY-IN-PLACE BLOW GUN EXTENSION

(71) Applicant: MAT INDUSTRIES, LLC, Long Grove, IL (US)

(72) Inventors: Gregory Kevin GRIFFIN, Humboldt, TN (US); Taixing ZOU, Ningbo (CN); Maojin ZHU, Ningbo (CN)

(21) Appl. No.: 18/766,250

(22) Filed: Jul. 8, 2024

Related U.S. Application Data
(60) Provisional application No. 63/518,584, filed on Aug. 10, 2023.

(51) Int. Cl. B05B 15/652; B05B 9/01; B08B 5/02

(52) U.S. Cl. CPC B05B 15/652; B05B 9/01; B08B 5/02

(57) ABSTRACT

An extension for a pneumatic blow gun includes a tube body defining an interior passage and having a first end and a second end, the body made of wound metal, a resilient liner disposed in the passage and extending from the first end to the second end; the first end configured for attachment to a barrel of the pneumatic blow gun; and the tube body being bendable per user manipulation, and being configured for retaining a user-manipulated orientation.

### RELATED APPLICATION

The present application claims 35 USC 119 priority from, and is a Non-Provisional of U.S. Ser. No. 63/518,584 filed Aug. 10, 2023, the entire contents of which are incorporated by reference herein

### BACKGROUND

The present invention relates generally to pneumatic tools powered by a compressor, and more specifically to an extension for such a tool, particularly a pneumatic blow gun.

Pneumatic blow guns are commonly used by mechanics, farmers, factory assemblers, technicians and the like for cleaning workpieces with blasts of compressed air. Such blow guns are particularly useful for cleaning where pressurized water is considered a corrosive or otherwise destructive element.

One common disadvantage of the use of conventional pneumatic blow guns is that the outlet at the end of a barrel of the blow gun is unable to reach into tight spaces or around hard to reach corners of a machine, vehicle or workspace for proper cleaning. Such conventional configurations often force the user to assume an awkward or uncomfortable position to fully clean the target. In some cases, even achieving such positions, the user is unable to adequately clean the workpiece.

One attempted solution to the above-described problem is to threadably attach a tubular, pipe-like extension to the barrel of the blow gun. While this is partially successful, the extension often makes the blow gun harder to manipulate, and becomes caught in the work area.

Thus, there is a need for an improved attachment for pneumatic blow guns that addresses the drawbacks discussed above.

### SUMMARY

The above-listed need is met or exceeded by the present flexible extension for a pneumatic blow gun, which is fabricated of a material which is flexible and manipulatable by the user to a desired non-linear orientation, and then retains that orientation until further user adjustment. In the present application, “non-linear” refers to an orientation not in a straight line. Preferably, a body of the extension includes a section of helically wound carbon steel spring. Also, to promote passage of compressed air through the extension while avoiding air leaks, a resilient liner is provided inside a passageway of the extension body. The liner is sufficiently flexible to accommodate the manipulation of the body while maintaining compressed air flow. Suitable fittings at each end of the extension body facilitate connection, respectively, to an outlet of the pneumatic blow gun, and to additional downstream pneumatic attachments.

More specifically, an extension for a pneumatic blow gun includes a tube body defining an interior passage and having a first end and a second end, the body made of wound metal, a resilient liner disposed in the passage and extending from the first end to the second end; the first end configured for attachment to a barrel of the pneumatic blow gun; and the tube body being bendable per user manipulation, and being configured for retaining a user-manipulated orientation.

In an embodiment, the tube body is covered with a resilient covering. In a preferred embodiment, the tube body is made of carbon spring steel.

In an embodiment, the first end is provided with a first ferrule surrounding the first end, and accommodates a threaded receptacle with a nipple for threadably engaging the barrel of the blow gun. In a preferred embodiment the nipple is a component of a barb fitting which is threadably engaged to a tube fitting configured for insertion into the liner.

In an embodiment, the second end is encompassed by a second ferrule, a brass bushing inserted into the liner, a compression ring pressing an outlet hex fitting against the second ferrule and around the brass bushing, and a retainer nut engaging the outlet hex fitting and compressing the compression ring against the fitting. In a preferred embodiment, the retainer nut is externally threaded for engaging the outlet hex fitting and retaining the compression ring in place.

In another embodiment, a combination pneumatic blow gun and flexible extension is provided, including a pneumatic blow gun having a body with a handle and a barrel, and defining an internal air passageway; a trigger connected to the body and configured for regulating the flow of compressed air in the internal air passageway; an inlet in the handle; an outlet at an end of the barrel for dispensing pressurized air as controlled by the trigger; the second end configured for threadable connection to pneumatic accessories; an extension tube body defining an interior passage and having a first end and a second end, the body made of wound metal; a resilient liner disposed in the passage and extending from the first end to the second end; the first end configured for attachment to the outlet of the pneumatic blow gun; and the tube body being bendable per user manipulation, and being configured for retaining a user-manipulated orientation.

### BRIEF DESCRIPTION OF THE DRAWINGS

FIG. 1 is a side elevation of the present flexible pneumatic blow gun extension;

FIG. 2 is a vertical cross-section of the extension of FIG. 1;

FIG. 3 is an exploded perspective view of the present flexible blow gun extension; and

FIG. 4 is a side elevation of the present flexible blow gun extension attached to a pneumatic blow gun.

### DETAILED DESCRIPTION

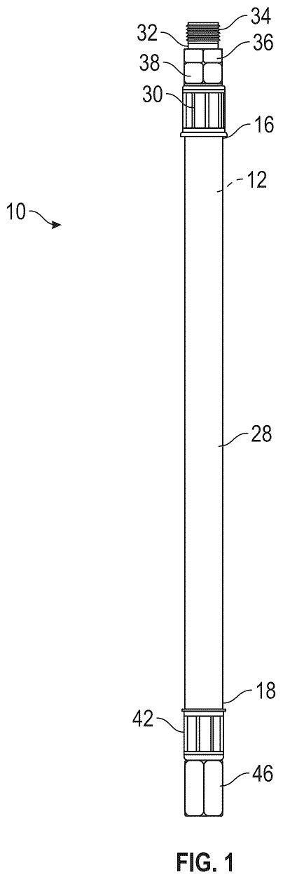

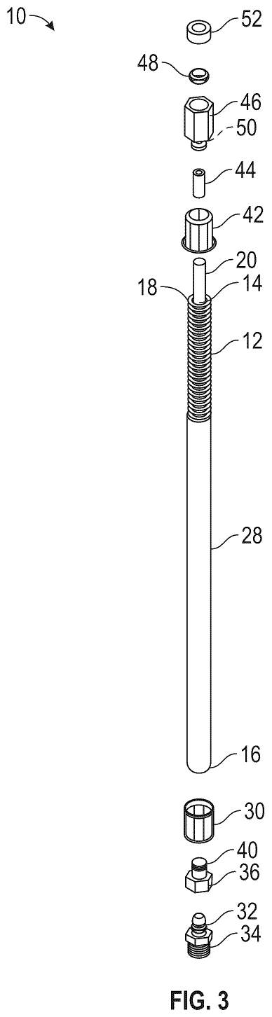

Referring now to FIGS. 1-3, the present pneumatic blow gun extension is generally designated 10. It is contemplated that the extension 10 is usable with other pneumatic appliances that emit compressed air, and as such is not exclusive to blow guns. As such, in the present application “blow guns” will be interpreted to refer to any such appliance that emits compressed air.

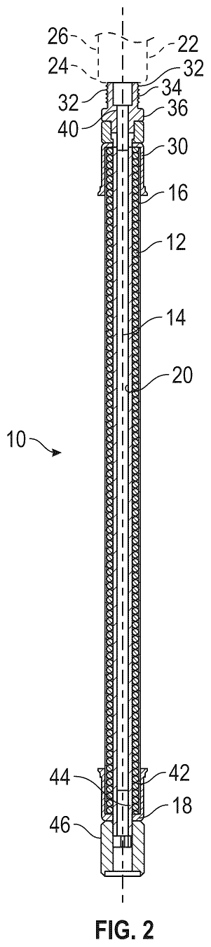

Included on the extension 10 is a tube body 12 defining an interior passage 14 (FIG. 2) and having a first end 16 and an opposite second end 18. In a preferred embodiment, the body 12 is made of wound metal, most preferably wound carbon steel spring. The body 12 is configured such that the helical wound coils are in contact with each other along an axial length of the body. An important feature of the present extension is that the tube body 12 is bendable into a variety of non-linear shapes per user manipulation, and is configured for retaining a user-manipulated orientation. The wound metal construction of the body is a major factor in achieving the desired performance of the extension. Accordingly, alternative materials with such bendable and shape-retaining properties are contemplated for the body 12.

Inside the interior passage 14, a tubular resilient liner 20 is disposed and extends from the first end 16 to the second end 18. Preferably, the liner 20 is made of a flexible material, such as rubber or the like, and is especially preferably made of polyurethane. As such, the liner 20 is configured for readily adapting to the manipulation of the body 12 and still maintaining desired flow of compressed air.

The first end 16 is configured for attachment to a barrel 22, more preferably an outlet 24 of a pneumatic blow gun 26. Also, it is preferred that the tube body 12 is covered with a sleeve-like resilient covering 28. A rubber-like material is preferred for the covering 28 for both flexibility and ease of maintenance. A first ferrule 30 is provided at the first end 16, surrounds and is tightly crimped to the first end. Also the first ferrule 30 accommodates a threaded receptacle 32 having a nipple 34 for threadably engaging the threaded outlet 24 at an end of the barrel 22 of the blow gun 26. In the preferred embodiment, the 34 nipple is a component of a barb fitting 36 which is threadably engaged to a tube fitting 38 and has an end 40 configured for insertion into the resilient liner 20 and through the first ferrule 30. Thus, the end 40 is in fluid communication with the liner 20.

At the second end 18, a second ferrule 42 encompasses and is crimped onto the second end, similarly to the first ferrule 30 on the first end 16, and as is well known in the art. A tubular brass bushing 44 is dimensioned for tight insertion into the resilient liner 20 and protrudes from the liner and through an outlet hex fitting 46. Thus, the brass bushing 44 is in fluid communication with the liner 20 and forms the connection point between the liner and the outlet hex fitting. A compression ring or washer 48 matingly engages the brass bushing 44 and presses the hex fitting 46 against the brass bushing 44 and the second end 18. The outlet hex fitting 46 has an internally threaded bore 50 and an externally threaded retainer nut 52 engages the threaded bore 50 and holds the compression ring 48 in position. Upon assembly, the extension 10 provides for flow of compressed air through the liner 20 from the barb fitting 36 to the outlet hex fitting 46 regardless of the user-manipulated positioning of the body 12. Also, the outlet hex fitting 46 is threaded to threadably engage a conventional pneumatic extension or other pneumatic fitting (not shown).

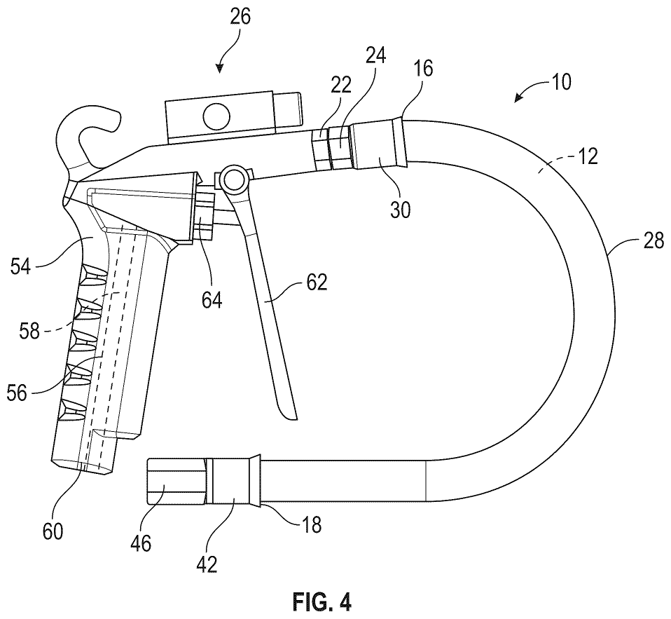

Referring now to FIG. 4, the pneumatic blow gun 26 is shown having a housing 54 with a handle 56 and the barrel 22. The housing 54 defines an internal air passageway 58 extending from an inlet 60 at the handle 56 to the outlet 24 at an end of the barrel 22. As is known in the art, the inlet 60 is preferably threaded for connection to a source of compressed air, usually produced by a compressor (not shown). Quick-connect fittings to achieve such connections are also contemplated, as are well known in the art.

A trigger 62 is pivotably connected to the housing 54 and is configured for regulating the flow of compressed air in the internal air passageway 58 for dispensing pressurized air.

Typically, the trigger 62 operates an internal valve 64 selectively opening and closing the internal air passageway 58. Preferably, the outlet 24 is threaded so as to threadably engage the nipple 34 at the first end 16 of the body 12 of the present extension 10. In FIG. 4, the extension 10 is shown mounted to the blow gun 26. In this position, due to the flexible nature of the construction of the tube body 12, the extension is user-manipulated into a variety of bends and shapes. Also due to the construction of the body 12, the manipulated shape is retained until the user elects to further manipulate the body shape. The presence of the resilient liner 20 and its connection to the first ferrule 30, the second ferrule 42 and the related connection components accommodates the user-manipulated non-linear positions and prevents compressed air from the blow gun 26 from leaking. A diffuser 66 is optionally secured to the barrel 22 or to the extension 10 and has lateral openings 68 for releasing pressure in the event the main outlet becomes plugged.

While a particular embodiment of the present flexible stay in place blow gun extension has been described herein, it will be appreciated by those skilled in the art that changes and modifications may be made thereto without departing from the invention in its broader aspects and as set forth in the following claims.

1. An extension for a pneumatic blow gun, comprising:
a tube body defining an interior passage and having a first end and a second end, said body made of wound metal;
a resilient liner disposed in said passage and extending from said first end to said second end;
said first end configured for attachment to a barrel of the pneumatic blow gun; and
said tube body being bendable per user manipulation, and being configured for retaining a user-manipulated orientation.

2. The extension of claim 1, wherein said tube body is covered with a resilient covering.

3. The extension of claim 1, wherein said tube body is made of carbon spring steel.

4. The extension of claim 1, wherein said first end is provided with a first ferrule surrounding said first end, and accommodating a threaded receptacle with a nipple for threadably engaging the barrel of the blow gun.

5. The extension of claim 4, wherein said nipple is a component of a barb fitting which is threadably engaged to a tube fitting configured for insertion into said liner.

6. The extension of claim 1, wherein said second end is encompassed by a second ferrule, a brass bushing inserted into said liner, and a compression ring pressing an outlet hex fitting against said second ferrule and around said brass bushing, and a retainer nut engaging said outlet hex fitting and compressing said compression ring against said fitting.

7. The extension of claim 6, wherein said retainer nut is externally threaded for engaging said outlet hex fitting and retaining said compression ring in place.

8. The extension of claim 6, wherein said outlet hex fitting is threaded to threadably engage a conventional pneumatic extension.

9. A combination pneumatic blow gun and flexible extension, comprising:
a pneumatic blow gun having a body with a handle and a barrel, and defining an internal air passageway;
a trigger connected to said body and configured for regulating the flow of compressed air in said internal air passageway;
an inlet in said handle;
an outlet at an end of said barrel for dispensing pressurized air as controlled by said trigger;
said second end configured for threadable connection to pneumatic accessories;
an extension tube body defining an interior passage and having a first end and a second end, said body made of wound metal;
a resilient liner disposed in said passage and extending from said first end to said second end;
said first end configured for attachment to said outlet of said pneumatic blow gun; and
said tube body being bendable per user manipulation, and being configured for retaining a user-manipulated orientation.

10. The combination of claim 9, wherein said extension tube body is covered with a resilient covering.

11. The combination of claim 9, wherein said extension tube body is made of carbon spring steel.

12. The combination of claim 9, wherein said first end is provided with a first ferrule surrounding said first end, and accommodating a threaded receptacle with a nipple for threadably engaging said outlet of said blow gun.

13. The combination of claim 12, wherein said nipple is a component of a barb fitting which is threadably engaged to a tube fitting configured for insertion into said liner.

14. The combination of claim 9, wherein said second end is encompassed by a second ferrule, a brass bushing inserted into said liner, and a compression ring pressing an outlet hex fitting against said second ferrule and around said brass bushing, and a retainer nut engaging said outlet hex fitting and compressing said compression ring against said fitting.

15. The combination of claim 14, wherein said retainer nut is externally threaded for engaging said outlet hex fitting and retaining said compression ring in place.

16. The combination of claim 14, wherein said outlet hex fitting is threaded to threadably engage a conventional pneumatic extension.
